(19) United States
(12) Patent Application Publication
(10) Pub. No.: US 2005/0187953 A1
(43) Pub. Date: Aug. 25, 2005

(54) Method and system for creating and administering entitlements in a wealth management system

(75) Inventors: Kenneth Chan, San Francisco, CA (US); Nicholas J. Willson, San Francisco, CA (US); June S. Ou, San Francisco, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Finaplex, Inc.

(21) Appl. No.: 11/059,999

(22) Filed: Feb. 17, 2005

Related U.S. Application Data
(60) Provisional application No. 60/547,151, filed on Feb. 24, 2004.

(51) Int. Cl. G06F 7/00

(52) U.S. Cl. 707/100

(57) ABSTRACT

A method and system for creating and administering entitlements in a wealth management system are disclosed. In one embodiment, a computer-implemented method, comprises associating a first entity and a second entity by a relation. A capability is applied to the first entity. A privilege is established that defines an entitlement of the relation to perform the capability to the first entity. The first entity, second entity, capability, and privilege are administered by a computer-implemented wealth management system.

The present application claims the benefit of and priority to U.S. Provisional Patent Application No. 60/547,151 entitled “Asset Management System” and filed on Feb. 24, 2004, and is hereby, incorporated by reference.

### FIELD OF THE INVENTION

The field of the invention relates generally to computer systems and more particularly relates to a method and system for creating and administering entitlements.

### BACKGROUND OF THE INVENTION

Wealth management companies generally follow a cyclical wealth management process to successfully acquire new customers and build loyal relationships with them. What makes some firms more successful than others, however, is how well they implement that process. Financial institutions strive to streamline operations, improve client loyalty, generate added revenue by rapidly developing and deploying new products and services to their customers, and achieve a real competitive advantage.

However, present wealth management solutions do not adequately address real business problems in the retail financial services industry: a lack of consolidated data, inefficient back- and mid-office operations and high client turnover.

One of the biggest challenges facing financial institutions today is a lack of data consolidation, generally caused by an incompatible mix of technology. Disparate applications perpetuate the “swivel chair” environment of reading data from one screen to key into another, resulting in errors and inconsistencies that take a significant toll on administrative efficiency and customer satisfaction.

Furthermore, wealth management companies fail in organizing the data stored in their systems to allow access in an intuitive manner. Understanding how pieces of data are interrelated is difficult to accomplish with present systems. These inadequacies are in part due to the development of the early systems that centered on an account holder's viewpoint. However, wealth is often managed, viewed, and represented by many different people and institutions. Present systems fail to provide a solution to the pains felt in the financial industry.

### SUMMARY

A method and system for creating and administering entitlements in a wealth management system are disclosed. In one embodiment, a computer-implemented method, comprises associating a first entity and a second entity by a relation. A capability is applied to the first entity. A privilege is established that defines an entitlement of the relation to perform the capability to the first entity. The first entity, second entity, capability, and privilege are administered by a computer-implemented wealth management system.

The above and other preferred features, including various novel details of implementation and combination of elements, will now be more particularly described with reference to the accompanying drawings and pointed out in the claims. It will be understood that the particular methods described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates a block diagram of an exemplary client-server system for providing the present method for social and business networking, according to one embodiment of the present invention;

FIG. 2 illustrates an exemplary computer architecture, according to one embodiment of the invention;

FIGS. 3A and 3B illustrate a block diagram of an exemplary financial application architecture, according to one embodiment of the present invention.;

FIG. 4 illustrates a block diagram of an exemplary entitlements component, according to one embodiment of the present invention; and

FIG. 5 illustrates a flow diagram of an exemplary process for administering entitlements in a wealth management system, according to one embodiment of the present invention.

### DETAILED DESCRIPTION

A method and system for creating and administering entitlements in a wealth management system are disclosed. In one embodiment, a computer-implemented method, comprises associating a first entity and a second entity by a relation. A capability is applied to the first entity. A privilege is established that defines an entitlement of the relation to perform the capability to the first entity. The first entity, second entity, capability, and privilege are administered by a computer-implemented wealth management system.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

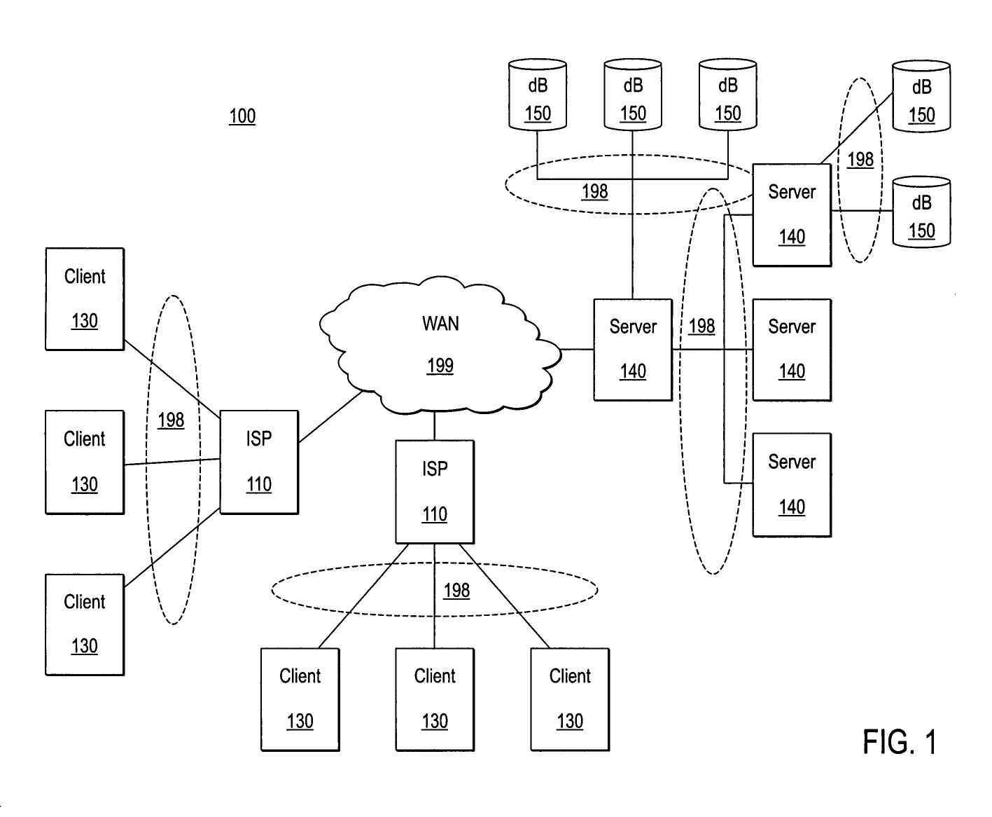

Turning to the figures, the presently preferred apparatus and methods of the present teachings will now be described. FIG. 1 illustrates a block diagram of an exemplary client-server system 100 for providing the present method for social and business networking, according to one embodiment of the present invention. All elements of the client-server system 100 are interconnected via a network. The network connecting all elements of client-server system 100 may be any wide area network (WAN) 199, or local area network (LAN) 198, or combination of LAN and WAN, generally referred to as the Internet.

In general, the network architecture described herein may be implemented as a standard telephone connection provided through an Internet service provider 110 to enable data communication on the Internet over a conventional telephone network. This use of the Internet as a distribution network is well known to those of ordinary skill in the art. In an alternate embodiment through the use of cable modem technology, communication may be performed over a conventional cable network in lieu of, or in addition to, communication over the telephone network via an ISP 110. In another alternate embodiment, through Integrated Services Digital Network (ISDN) technology, the network is accessed using an ISDN modem, also via an ISP 110. Both clients 130 and servers 140 can access the Internet through the architectures described above.

The clients 130 and servers 140 can be any type of computing device including a personal computer. The workstations (clients 130 and servers 140) may be a combination of proxy servers, web servers, application servers, and database servers. Web servers are responsible for handling the incoming client requests, decrypting the secure connection, bridging to the application server for dynamic content, and serving static content. Web servers tend to have relatively little load since the majority of the application is dynamic in nature. The management and gateway servers take care of periodic batch processes, integration tasks, and other monitoring functions. Performing these functions on dedicated machines but often provides an enhanced level of security by better isolating the application servers and providing finer grained control of system resources. The application servers run the business components and related functionality. Typically, the J2EE web application executes on the application servers along with the EJB and middleware components for enhanced performance, though these functions can be separated if desired.

Workstations (clients 130 and servers 140) may be any of a SUN Ultra 60, Ultra 80, Ultra 450, Blade 1000, HPJ6000, IBM RS/6000 F80, Dell Workstation 530, IBM Intellistation ZPro 6866, Intel Server, IBM I-Series Server, IBM Z-Series Server, or similar computing device. Various operating systems are supported on the workstations, such as Sun Solaris, AIX, Win 2000, zOS, Linux, and MacOS. Workstations also run various software components such as iPlanet, Apache, WebLogic 7, and WebSphere 5.x.

Typically, databases 150 will comprise a SQL (structured query language) relational database management system (RDBMS) database, such as one of the SQL RDBMS database products provided by Oracle (Oracle 8i, 9i), Microsoft (SQL Server 7), Sybase, IBM (DB2) and Informix. Optionally, the databases 150 may comprise a non-SQL-based server product, such as the Microsoft's Access database or Paradox. The database servers run queries against the data models and execute data manipulation stored procedures. The wealth management data can be quite large, as major institutions will keep 18 months or more of historical data online across a wide customer base. According to one embodiment, RAID disk arrays are attached to the database server locally to provide local storage and facilitate high availability. The database machines, however, tend to use either fiber channel loops or a SAN to make a large, redundant storage array available to the database servers. This provides high performance across all the machines and minimizes the overhead and tasks required for system redundancy. Financial application architecture 300 supports both standard UNIX and Windows environments and selected database and management components can run on OS/390 as well.

Note that any or all of the components of the system illustrated in FIG. 1 and associated hardware may be used in various embodiments of the present invention; however, it will be appreciated by those of ordinary skill in the art that any configuration of the system may be used for various purposes according to the particular implementation.

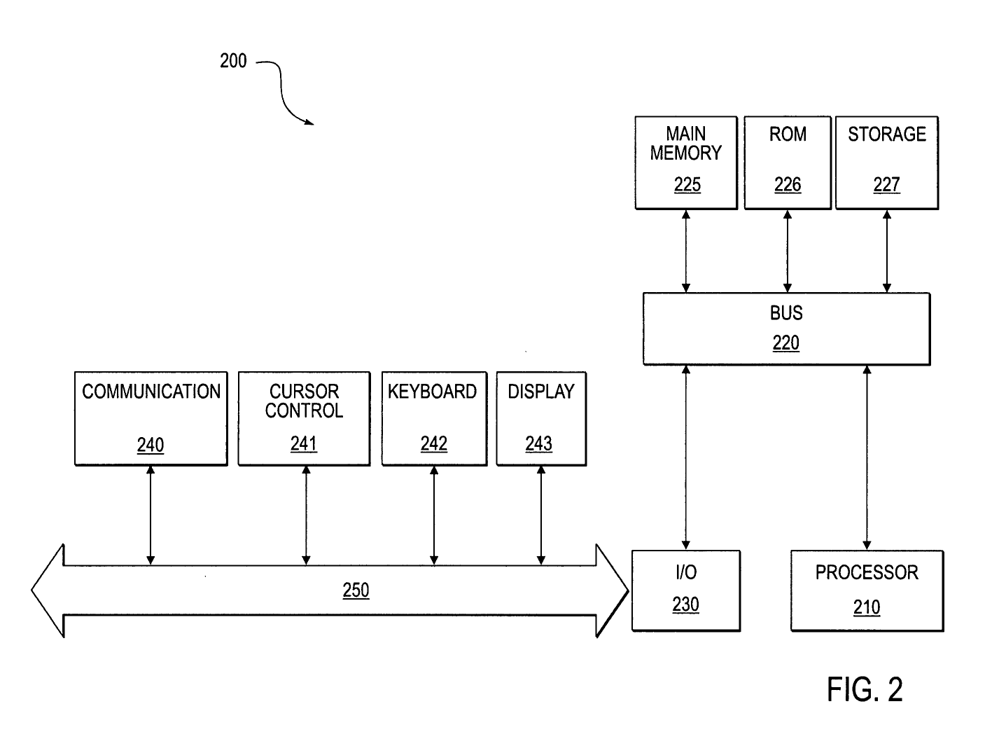

FIG. 2 illustrates an exemplary computer architecture, according to one embodiment of the invention. Computer architecture 200 can be used to implement both clients 130 and servers 140 of FIG. 1. One embodiment of architecture 200 comprises a system bus 220 for communicating information, and a processor 210 coupled to bus 220 for processing information. Architecture 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Architecture 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Architecture 200 can also be coupled to a second I/O bus 250 via an I/O interface 230. A plurality of I/O devices may be coupled to I/O bus 250, including a display device 243, an input device (e.g., an alphanumeric input device 242 and/or a cursor control device 241). For example, web pages and business related information may be presented to the user on the display device 243.

The communication device 240 is for accessing other computers (servers or clients) via a network. The communication device 240 may comprise a modem, a network interface card, a wireless network interface or other well known interface device, such as those used for coupling to Ethernet, token ring, or other types of networks.

Having described the hardware architecture of clients 130 and servers 140, a description follows of the operating system and software used to perform the features described herein. Internet browsing is implemented through client computers 130, HTTP server computers 140 and HTTP browsers. Servers 140 play the role of archives for providing data, and client 130 play the role of customers or consumers of the data. Typically many clients connect to a single server. Special server and client software may also be employed, depending on the specific application design architecture.

An Internet browser, such as Microsoft's Internet Explorer or Netscape's Communicator, is a piece of software which resides on a client computer. When executed by a user, the browser opens a Uniform Resource Locator (URL), which resides on a server 140. Typically, the URL is a Hyper-Text Markup Language (HTML) page, which is sent back from the server 140 to the client 130. The HTML page has instructions for the browser, which instruct the browser how to render the page for display. The page typically has additional URLs embedded in it, and when the user clicks on one of them, the server 140 then sends a new HTML page for the browser to render.

HTML pages can contain both text and graphics, along with layout instructions. Images appearing on an HTML page also reside on the server 140, and are sent to the client 130 when the browser finds a link to an image on the HTML page it is rendering, and then instructs the server 140 to send image data. The beauty of this is that the images reside on remote computers, and do not have to be stored locally on the client 130. Otherwise, the client would have to store every image it views, either on its hard disk or on a storage medium such as CD-ROM, regularly replacing these images with updates. Both images and data can be stored in databases 150 that are attached to servers 140 directly or through network(s) 198.

The actual data communication between the server 140 and the client 130 is governed by Internet protocols, such as Hyper-Text Transfer Protocol (HTTP). These protocols define packets of data to be sent, and can include handshakes for negotiating data-link control, to verify if the data arrived intact. Specifically, the HTTP protocol sits as a layer on top of TCP/IP protocol.

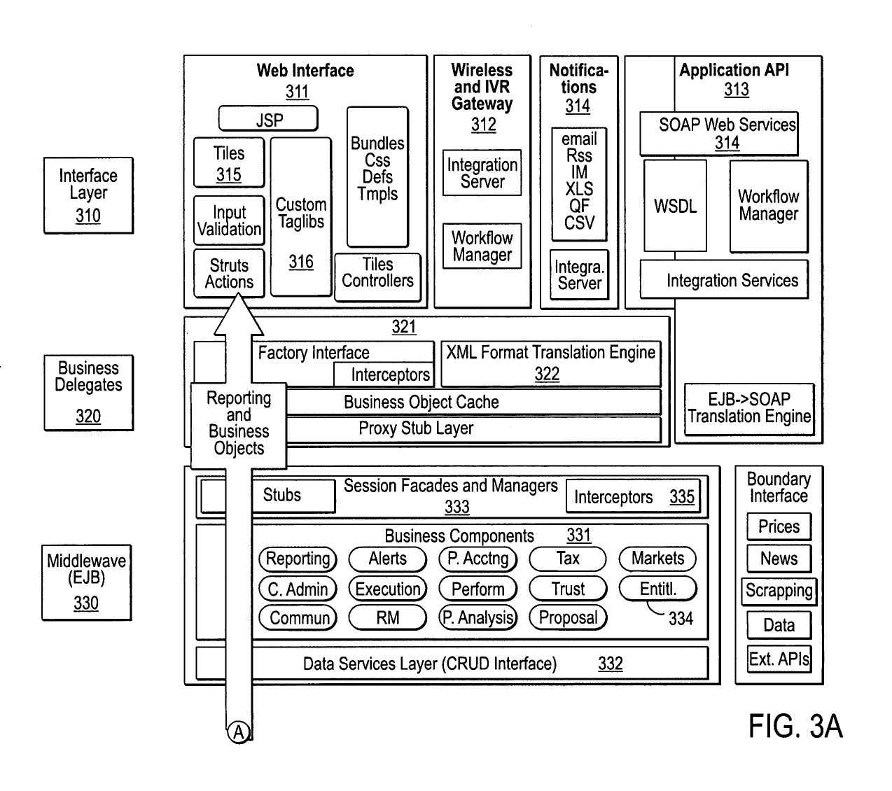

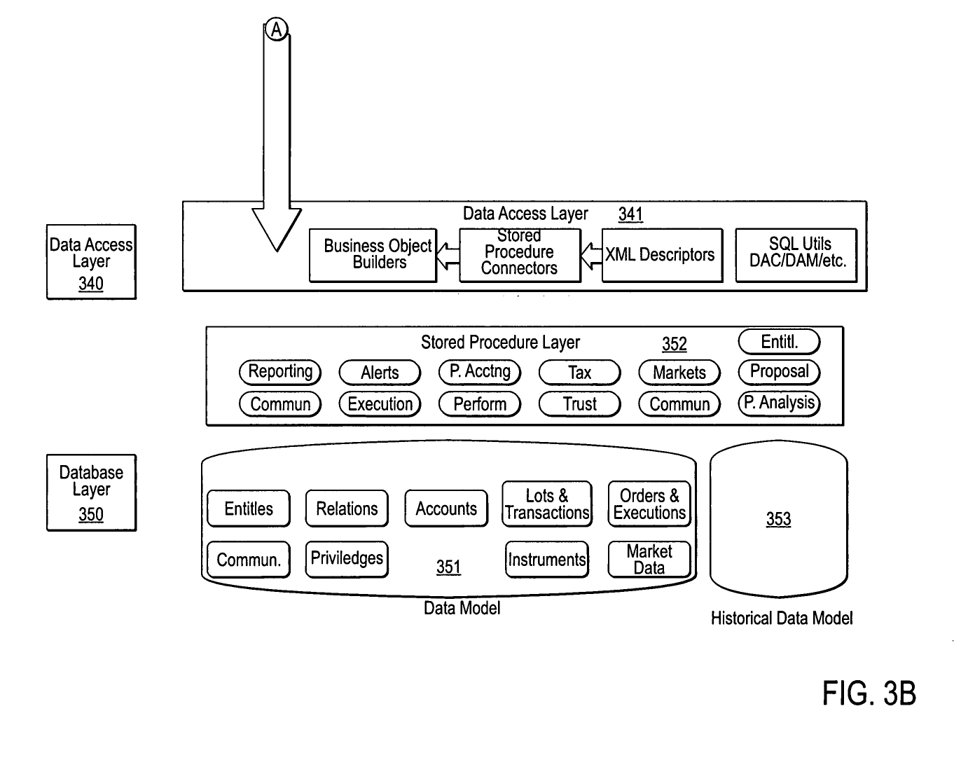

FIGS. 3A and 3B illustrates a block diagram of an exemplary financial application architecture, according to one embodiment of the present invention. Financial application architecture 300 is a comprehensive application suite that services the needs of all key participants in the wealth management cycle. In one embodiment, financial application architecture 300 takes advantage of J2EE standards using common industry leader and open source web, application, and database servers. These standards are laid out in a tiered application that provides high performance, flexible deployment, multitudinous interfaces, and future scalability. Redundant server stacks can be configured in a number of arrangements to utilize both commodity and high-end hardware to achieve high availability and expand capacity as deployment scale increases.

The software architecture of financial application architecture 300 provides a flexible core of functionality that lets each of the actors in the wealth management cycle to perform their functions through a holistic suite of technology. Financial application architecture 300 is flexible, fast, intuitive, and highly customizable for each user. At the same time, financial application architecture 300 integrates all the user's data together into a single coherent structure and allow interactions between users to be coordinated in a consistent fashion. Financial application architecture 300 is also customizable and extensible from the start, allowing professional services, clients, or third parties to easily integrate it with existing systems or build new front ends on top of proprietary components.

The core of financial application architecture 300 is the data model 351, which is the first of its kind in integrating all types of wealth data into a single coherent structure. The data model 351 is a normalized relational database (such as database 150) with selected performance enhancements that blend well-linked, easy to use data, with fast application response and easy data maintenance. Data model 351 is further extended by a companion historical database 353 that integrates with the data model 351 and integrated data manipulation logic, which provides high performance across large reports and data sets.

Financial application architecture 300 is delivered primarily as a web application. A web interface 311 provides the most pervasive interface which is readily accessible and familiar to both client institutions (users) and their customers. Web applications are also simple to interact with and make it easy to navigate among large quantities of information. Financial application architecture 300 additionally supports the web interface with wireless 312, voice 312, notification 314, and application 313 interfaces discussed below.

J2EE is an enterprise Java platform used for constructing web interface 311 that makes it easy to build flexible, yet powerful web applications and integrate them with databases. J2EE also provides an attractive technology platform on which to develop and deploy the business components of financial application architecture 300. J2EE was additionally selected due to the strong vendor and open source support for the technology suite and the ability to use existing technology for many of our needs.

To enhance the web interface 311, financial application architecture 300 provides an application API 313 that is provided natively through the web. API 313 is implemented as a SOAP web service 314, which combines well structured data, simple cross language/platform bindings, and well formed error handling. API 313 also provides support for wireless 312, IVR 312, and syndication. Each layer of financial application architecture 300 will be described below.

Database layer 350 includes data model 351. Data model 351 is responsible for organizing the user (financial organization) and customer (financial organization's customer) wealth information into a single consistent schema. This schema is a normalized modeling of the full range of data required for wealth management, with performance tweaks that enable high performance against large or complex queries. Financial application architecture 300 data model 351 is a comprehensive structure with over 300 tables and accommodates a wide range of complicated data including detailed accounting, fine grained permissions, complex trust and estate relationships, and historical snapshots and audit histories. Historical data model 353 is optimized for time series data while still integrating with data model 351. Data model 351 is designed to be compatible with a variety of database vendor's products, although according to one embodiment Oracle is used.

Database layer 350 also includes stored procedures layer 352. The data manipulation tasks of the business components 331 are implemented as stored procedures 352 in the database layer 350. This allows for very fast response times across large data sets and powerful queries able to winnow particular details without advanced planning.

Data access layer 340 provides a powerful binding between the relational data and stored procedure results 352 and the object oriented business components 331 used to build the web interface 311. The data access layer 340 automatically generates the proper bindings to create the appropriate business objects for a particular query or action.

Middleware layer 330 includes a data services layer 332. Financial application architecture 300 abstracts a data services layer 332 underlying its business components 331 to allow for simple integration with a variety of systems. The data services layer 332 has a granular interface for working with basic data elements such as entities, accounts, lots, transactions, and instruments. The data services layer 332 is used internally to ensure that all data interface is made in a consistent manner and has well formed validation, concurrency checking and also provides a low level external interface that can be used for high performance data integration and system of record reconciliation.

Middleware layer 330 also includes business components 331. Business components 331 are reusable components that provide a repertoire of capabilities that can be drawn upon by web 311 and other interfaces. Business components 331 cover a range of functions from reporting, and relationship management to entitlements. Entitlements component 334 allows for the control, delegation, assignment, monitoring, and execution of access privileges, according to access rules. For example, a trustee manages the accounts in a trust, but a beneficiary can only see certain aspects of the accounts, and then only as determined by the trustee.

Middleware layer 330 also includes session facade and managers 333. The session facade and managers 333 simplify interaction with business components 331. The facades provide a single point of access for complex behaviors within the business components 331 without requiring callers of this interface to worry about serialization, transactions, ancillary data, or other complexities. Facades 333 also encapsulate much of the workflow of the wealth management cycle and provide the ability to use interceptors 335 to extend existing functionality without having to change the existing components.

The business delegate layer 320 is a bridge between the interface layer 310 and the middleware layer 330. The function of the business delegates 321 is to further simplify building highly customized interfaces while also improving performance through caching. The business delegate layer 320 also has a format translation engine 322 that can marshal data into xml formats for many different types of system integration.

The interface layer 310 includes a web user interface 311 that provides a series of portals oriented around the workflow of the actors in the wealth management cycle. Struts and tiles 315 are used to create a MVC (model-view-controller) framework that make reuse easy and provide high performance and customizability at the same time. Custom tags 316 are used for simpler data driven elements. Tile templates, definitions, and css/png graphical presentation allow for highly flexible client branding. All of these elements are pulled together into a usability-oriented interface 311 that emphasizes the workflow and navigation patterns of the end user and hides the robust and complex components that are drawn upon to create these screens.

Web interface 311 is a very effective mechanism for working with customers currently engaged in a wealth management function, but has weaknesses in serving end users not currently at their computer or applications needing to integrate with financial application architecture 300. In addition to the primary web interface 311, a range of other mechanisms of interacting with the application are provided. Offline users can employ wireless (WML/cHTML) 312, voice, and notification 314 (email, instant messaging, rss, etc.) systems to stay abreast of key events or information accessible via financial application architecture 300. A SOAP web services API 314 makes application integration easy, cross-platform, yet robust with well-structured data, interfaces, and error handling. Workflow, integration, and translation servers encapsulate common behaviors across these systems and tailor the customer experience appropriately to the medium being used.

Other software used by Financial application architecture 300 includes open source Java technology such as Apache's Struts, Taglibs, Tiles, Axis, and Cocoon; JDOM, JXL, JAX, Log4J, and Xerces Java libraries; perl for scripting; Junit, Cactus, and Grinder testing frameworks; etc. Technowledge or Yodlee commercial packages can be used for web based data integration and Kava for Java based charting. Additional software is used for monitoring, networking, and management.

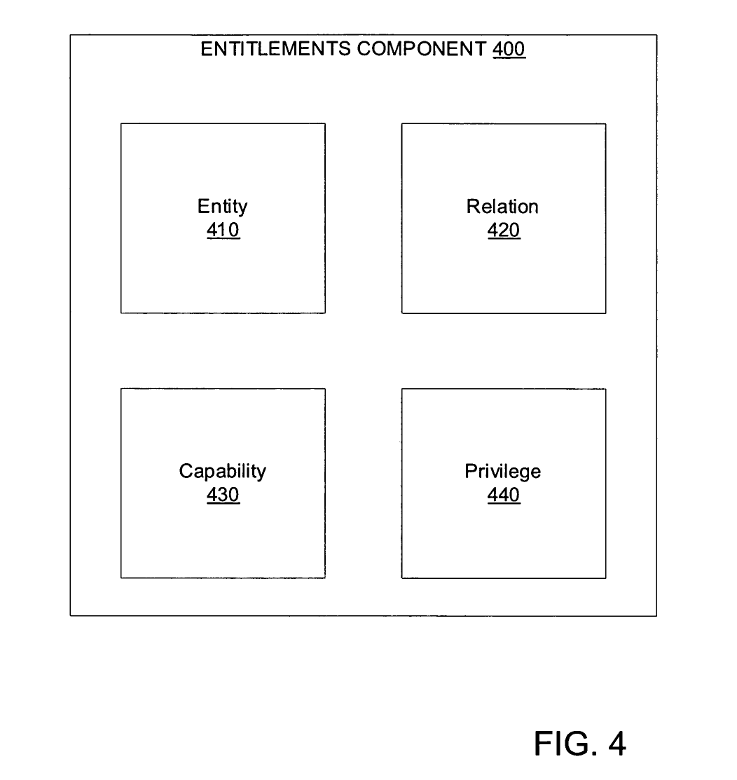

FIG. 4 illustrates a block diagram of an exemplary entitlements component, according to one embodiment of the present invention. Entitlements component 400 allows for the control, delegation, assignment, monitoring, and execution of access privileges, according to access rules. For example, suppose an administrator has just made member05 the trustee of a trust. A relation is formed between the trustee and the trust. The relations implies that a particular set of capabilities now apply to the trustee and allows the trustee to perform certain functions on the trust. Automatically, entitlements component 400 determines that member05 now has administrative privileges on all accounts owned by the trust. Therefore, member05 can now navigate to a screen to administer account access to all of the beneficiaries of the trust.

The identities of the accounts, of the beneficiaries, and of the accesses that member05 can grant are all determined by data-driven code. If professional services or a ‘super admin’ changes the rules, then member05's abilities to grant are automatically changed accordingly. No code change or redeployment is necessary. The entities to support this framework follow, from most fundamental to those with more dependencies.

The entitlement component framework 400 is metadata driven and therefore flexible and dynamic. The key elements of the framework are entity element 410, relation element 420, capability element 430, and privilege element 440.

An entity 410 in the entitlement component framework 400 is defined as any “important” business structure—e.g., tangible, self-contained content in the data model 351 that relates to one or more additional business structures—where rules can be applied about entitlements to individual instances of the “entity” 410. For example, an account is an entity 410 because access may be granted or withheld on an individual account basis (e.g., one can see Account 23 but not Account 98). A transaction is not an entity 410 because access is not granted or withheld on individual transactions. All the transactions in Account 23 can be viewed or none of them, but access is not granted or withheld to transaction 3457001 in Account 23.

Another example relates to site access. A feature within the product—such as portfolio distribution—is not an entity. The user is the entity 410, and the user can either see or not see the portfolio distribution module. The following are additional examples of the major business structures that are entities 410, including:

Accounts

Account Groups (named, book of business, etc.)

People

Institutions

Legal Vehicles (e.g., trusts, etc.)

Other business structures, although important, do not qualify as entities—for example, transactions, notes, news items and phone numbers are not entities. Access to these business structures is administered through the entity they “belong to”, such as the account that contains transactions, or the person who has phone number(s).

Relation element 420 establishes relationships between entities 410. Every entity 410 is related to at least one other entity 410. A client is represented as a relation 420 from a person to an institution. Relations 420 enable the management of complex structures: Carol is also a Trustee of a Trust, of which Billy is a Beneficiary, the Trust is a General Partner of a Partnership, the Partnership Owns some Accounts, the Partnership is itself the General Partner of another Partnership, and so on. For example, Generic Bank is an institution entity. Barry and Carol are person entities. A relation Client from Carol to Generic Bank is used to show that Carol is a client. Another relation Banker goes from Barry to Carol. Barry has such a relation for each of his clients. Barry also has a relation Advisor to show that he acts for Generic Bank.

A capability element 430 represents an action that can be applied to an entity 410 and which serves as the granularity levels of entitlement. Either you are entitled to perform the action on the entity, or you are not. For example, on the entity Account, there is a capability “Read Balance Sheet”. One can read Account 23's balance sheet, or you cannot, there is no intermediate entitlement. Most actions performed in the financial application architecture 300 are performed via a capability 430. Reading a balance sheet, sending a message to a person, registering a new customer, setting alert preferences on an account, are all performed in terms of one or more capabilities 430 on some underlying entities 410.

A privilege element 440 ties together entities 410, capabilities 430 and relations 420. A privilege 440 represents the entitlement of some party to do some action to some target. The party is represented by a relation 420. The action is represented by a capability 430. The target is represented by an entity 410. For example, for each account where Carol can read the balance sheet, there is a privilege 440. Carol can read the balance sheet on her own accounts and possibly other accounts too. For each of these accounts, Carol has a privilege 440 that looks like this:
The relation 420 that has the privilege 440: the relation 420 between Carol and Generic Bank as a Client. The capability 430 that can be performed: Read Balance Sheet on Account. The target entity 410: Account 23.

Because a privilege belongs to a relation 420, Carol reads Account 23 as a Client, not directly as Carol. If Carol has other relations 420 that she can use to do things, then other privileges 440 apply, depending on which relation 420 she is using at the time. For example, in addition to being a Client, Carol is a member of Charles's family office. Carol can act not only as a Client but also, if she chooses, as an Interested Party on behalf of Charles. As a Client, Carol cannot see any of Charles's accounts, but as an Interested Party, she can see those of Charles's accounts that Charles has chosen to let her see. For Charles's accounts, the privilege looks like this:
The Relation that has the privilege: the relation between Carol and Charles as Interested Party. The Capability that can be performed: Read Balance Sheet on Account. The target Entity: Account 23.

Privilege 440 (entitlement) can be explicit or implicit. An explicit entitlement is an action that creates an access privilege for a user for a particular entity. An implicit entitlement is a privilege that is created based on a relationship of an entity to another entity. An example of an explicit entitlement is as follows: A customer adds an interested party to his family office structure. This interested party is an estate-planning attorney. The customer wants the attorney to see some, but not all, of his assets. The customer explicitly entitles the attorney to have view access to 5 of his 10 accounts. The attorney logs in and sees only the accounts—and their corresponding assets—to which the customer set view access. The attorney might have site access to all of the reports and functionality that the client has, but with a limited asset set. Thus, on pages such as net worth where there is a summary value (as opposed to explicit accounts and corresponding market values), the numbers would not be identical between attorney and client.

An example of implicit entitlement is as follows: An irrevocable trust has the following relationships: one grantor, two trustees, three current beneficiaries. The irrevocable trust instrument implies entitlement: the grantor has access to the trust instrument itself, but the assets within the trust are not included in the grantor's portfolio. The trustees have full access to view as well as to manage trust assets. The current beneficiary has no access to the trust assets. If either of the trustees decides to manage the trust by liquidating an account to invest in a non-financial asset, the financial application architecture 300 will “fix” the entitlement such that the second trustee will automatically have the correct access to the new assets. The entitlement of the assets to the trustee is done by the relationship, not by the specific assets within the trust.

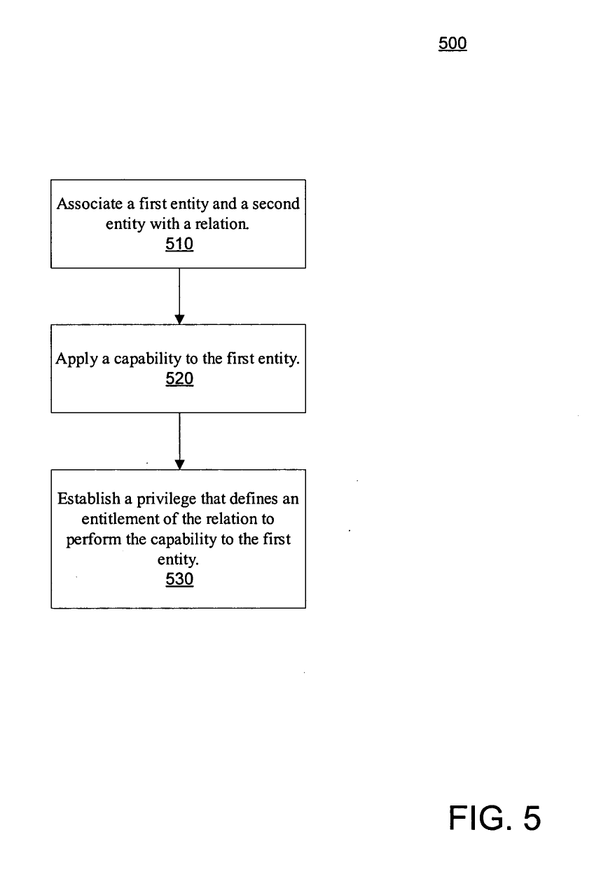

FIG. 5 illustrates a flow diagram of an exemplary process for administering entitlements in a wealth management system, according to one embodiment of the present invention. Entitlements process 500 associates a first entity and a second entity with a relation. (block 510) For example, Generic Bank is an institution entity. Barry and Carol are person entities. A relation Client is used from Carol to Generic Bank to show that Carol is a client. A capability is applied to an entity. (block 520) For example, reading a balance sheet, sending a message to a person, registering a new customer, setting alert preferences on an account, are all performed in terms of one or more capabilities 430 on some underlying entities 410. A privilege is established that defines an entitlement of the relation to perform the capability to the entity. For example, for each account where Carol can read the balance sheet, there is a privilege 440 allowing her to read the balance sheet on her own accounts and possibly other accounts too. This process controls all entities within financial application architecture 300.

A method and system for creating and administering entitlements in a wealth management system has been described with respect to specific examples and subsystems, it will be apparent to those of ordinary skill in the art that it is not limited to these specific examples or subsystems but extends to other embodiments as well.

1. A computer-implemented method, comprising:
associating a first entity and a second entity by a relation;
allowing a capability to be applied to the first entity; and
establishing a privilege that defines an entitlement of the relation to perform the capability to the first entity;
wherein the first entity, second entity, capability, and privilege are administered by a computer-implemented wealth management system.

2. The computer-implemented method of claim 1, wherein entities include firms, accounts, users, trusts, and groups.

3. The computer-implemented method of claim 2, wherein relations include client, trustee, beneficiary, general partner, and advisor.

4. The computer-implemented method of claim 3, wherein an entity has business structures including transactions, notes, and phone numbers.

5. The computer-implemented method of claim 4, wherein the privilege is an explicit entitlement.

6. The computer-implemented method of claim 4, wherein the privilege is an implicit entitlement.

7. A computer-readable medium having stored thereon a plurality of instructions, said plurality of instructions when executed by a computer, cause said computer to perform:
associating a first entity and a second entity by a relation;
allowing a capability to be applied to the first entity; and
establishing a privilege that defines an entitlement of the relation to perform the capability to the first entity;
wherein the first entity, second entity, capability, and privilege are administered by a computer-implemented wealth management system.

8. The computer-readable medium of claim 7, wherein entities include firms, accounts, users, trusts, and groups.

9. The computer-readable medium of claim 8, wherein relations include client, trustee, beneficiary, general partner, and advisor.

10. The computer-readable medium of claim 9, wherein an entity has business structures including transactions, notes, and phone numbers.

11. The computer-readable medium of claim 10, wherein the privilege is an explicit entitlement.

12. The computer-readable medium of claim 10, wherein the privilege is an implicit entitlement.

13. A system, comprising:
a processor; and
a storage device coupled to the processor, wherein the storage device stores instructions, the processor executing the instructions to associate a first entity and a second entity by a relation, allow a capability to be applied to the first entity; and establish a privilege that defines an entitlement of the relation to perform the capability to the first entity, wherein the first entity, second entity, capability, and privilege are administered by a computer-implemented wealth management system.

14. The system of claim 7, wherein entities include firms, accounts, users, trusts, and groups.

15. The system of claim 8, wherein relations include client, trustee, beneficiary, general partner, and advisor.

16. The system of claim 9, wherein an entity has business structures including transactions, notes, and phone numbers.

17. The system of claim 10, wherein the privilege is an explicit entitlement.

18. The system of claim 10, wherein the privilege is an implicit entitlement.
